(19) United States
(12) Patent Application Publication
(10) Pub. No.: US 2023/0242426 A1
(43) Pub. Date: Aug. 3, 2023

(54) Method of Removing Organic Pollutants in Water by Zero-Valent Iron Enhanced Hypochlorite

(71) Applicant: Harbin Institute of Technology, Harbin City (CN)

(72) Inventors: Lu WANG, Harbin (CN); Jun MA, Harbin (CN); Yulei LIU, Harbin (CN)

(21) Appl. No.: 18/149,080

(22) Filed: Dec. 31, 2022

(30) Foreign Application Priority Data
Jan. 29, 2022 (CN) 202210111576.X

(51) Int. Cl. C02F 1/76; C02F 1/66

(52) U.S. Cl. CPC C02F 1/76; C02F 1/66; C02F 2305/026; C02F 2101/34

(57) ABSTRACT

A method of removing organic pollutants in water by zero-valent iron enhanced hypochlorite includes the steps of: adjusting a pH of raw water containing organic pollutants to 4.0˜9.0; adding zero-valent iron solid and hypochlorite to the raw water in a mixer; and turning on the mixer to carry out stirring reaction. The method constructs a Fenton-like system through the redox reaction in the heterogeneous micro-interface region that occurs between zero-valent iron and hypochlorite which produces a variety of active oxidizing species with high occurrence, improves the shortcomings of the traditional Fenton method, broadens the applicable range of pH, and increases the removal efficiency of pollutants in water by 35˜95%.

### CROSS REFERENCE OF RELATED APPLICATION

This application claims priority to Chinese application number 202210111576.X, filed on Jan. 29, 2022. The contents of these specifications are incorporated herein by reference.

### BACKGROUND OF THE PRESENT INVENTION

### Field of Invention

The present invention relates to a method of zero-valent iron enhanced hypochlorite to remove organic pollutants in water.

### Description of Related Arts

In recent years, the wastewater generation has multiplied with the rapid growth of the country's population and industrialization. A large number of organic pollutants and inorganic pollutants, such as benzoic acid in chemical raw materials, atrazine in pesticides, and carbamazepine in drugs, etc. flow into water bodies, and the pollution situation in the water environment field is not optimistic. These pollutants are very harmful. Even if the content in the environment is very low, they will cause strong toxicological effects and ecological hazards, seriously threatening human health and safety. There is an urgent need to research for a better pollutant control and removal in water.

Chemical oxidation is one of the most commonly used technical means to effectively remove pollutants in water. Oxidation techniques such as chlorine, chlorine dioxide, high iron, high manganese, and advanced oxidation are commonly used. Advanced oxidation, which has strong oxidation ability and can convert most organic pollutants into carbon dioxide, water, inorganic ions and small molecular compounds, greatly reduces pollution and has attracted widespread attention. The Fenton process is one of the most promising processing technologies. However, there are still some problems in the practical application of Fenton reaction, such as narrow applicable pH range, low utilization rate of hydrogen peroxide, excessive dosage and high investment cost. Therefore, the Fenton-like system has gradually attracted people's attention. On the one hand, researchers promote the generation of free radicals in the system by introducing energy sources such as light, electric current, and ultrasound; on the other hand, they study and improve the traditional Fenton reagent, hoping to improve the processing capacity of the Fenton system while eliminating its negative effects as much as possible.

### SUMMARY OF THE PRESENT INVENTION

An object of the present invention is to solve the low removal efficiency of some typical pollutants in the existing Fenton water treatment process, especially to solve the problems such as the low utilization rate of hydrogen peroxide in the traditional Fenton reaction, the excessive dosage requirement and the high investment costs. Accordingly, the present invention provides a method of removing organic pollutants in water by zero-valent iron enhanced hypochlorite.

According to the present invention, the method of removing organic pollutants in water by zero-valent iron enhanced hypochlorite comprises the following steps:

(a) weighing zero-valent iron in solid form;

(b) preparing a mother liquor of hypochlorite;

(c) adjusting a pH of raw water containing organic pollutants to 4.0˜9.0;

(d) adding the zero-valent iron in solid form and the mother liquor of hypochlorite to the raw water containing organic pollutants in a mixer, where a final concentration of the hypochlorite in the mixer is 0.02˜5 mmol/L;

(e) turning on the mixer to carry out a stirring reaction to remove the organic pollutants in the raw water.

The advantageous effect of the method for zero-valent iron-enhanced hypochlorite to remove organic pollutants in water according to the present invention are as follows:

(1) First, as a reducing agent, zero-valent iron can generate highly active hydroxyl radicals through one-electron and two-electron reaction pathways to convert and degrade pollutants in Fenton or Fenton-like systems. Second, compared with ferrous iron, zero-valent iron, which functioned as a reducing agent, has a stronger reducing ability and can provide more electrons in the reaction process. Third, compared with the homogeneous reaction involving ferrous iron, the redox reaction involving zero-valent iron particles occurs at the liquid-solid two-phase interface. Based on the micro-interface effect and confined space effect, the reaction conversion efficiency is higher, the reaction rate is faster, and the effect of removing organic pollutants in water is better.

(2) Hypochlorite is usually used as a disinfectant in water treatment. Compared with other chemicals, it has the advantages of strong oxidation, convenient transportation and storage, and low price. Replacing hydrogen peroxide in the Fenton system with hypochlorite is not only more effective but also has lower cost. During operation, the pH value can be extended to weakly acidic conditions, which can break through the bottleneck problem of the traditional Fenton method.

According to the method for removing organic pollutants in water by zero-valent iron enhanced hypochlorite of the present invention, the reaction mechanism is a redox reaction in the heterogeneous micro-interface region that occurs through zero-valent iron and hypochlorite. In the system, a variety of high-occurrence active oxidizing species such as hydroxyl free radicals, singlet oxygen, peroxyl free radicals, intermediate valence iron, chlorine free radicals and chlorine oxygen free radicals are produced. As a result, the removal efficiency of the system for organic pollutants in water can be increased by 35-95%.

For example, in the same reaction time, the removal rate of benzoic acid BA can be increased to 80-98%, compared with the removal rate of 3% by using hypochlorite alone and the removal rate of 40% by using zero-valent iron alone. The removal rate of carbamazepine CBZ can be increased to 88-99%, compared with the removal rate of 49% by using hypochlorite alone and the removal rate of 5% by using zero-valent iron alone. The removal rate of nitrobenzene NB can be increased to 74-95%, compared with the removal rate of 12% by using hypochlorite alone and the removal rate of 24% by using zero-valent iron alone. The removal rate of atrazine ATZ can be increased to 65-85%, compared with the removal rate of 10% by using hypochlorite alone and the removal rate of 5% by using zero-valent iron alone.

The method for removing organic pollutants in water by zero-valent iron enhanced hypochlorite of the present invention constructs a Fenton-like system, improves the shortcomings of the traditional Fenton method, broadens the scope of application of pH, reduces the waste of dosing, and reduces costs. Also, the effect of combination of the two elements, the zero-valent iron and the hypochlorite, has produced an unexpected result with a removal rate dramatically greater than that of the sum of removal rate of using each single element separately. In particular, the removal rate of pollutants in water is increased by 35-95% when compared to the sum of the removal rate of using each single element separately.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a flowchart of a method for removing organic pollutants in water by zero-valent iron enhanced hypochlorite according to a preferred embodiment of the present invention.

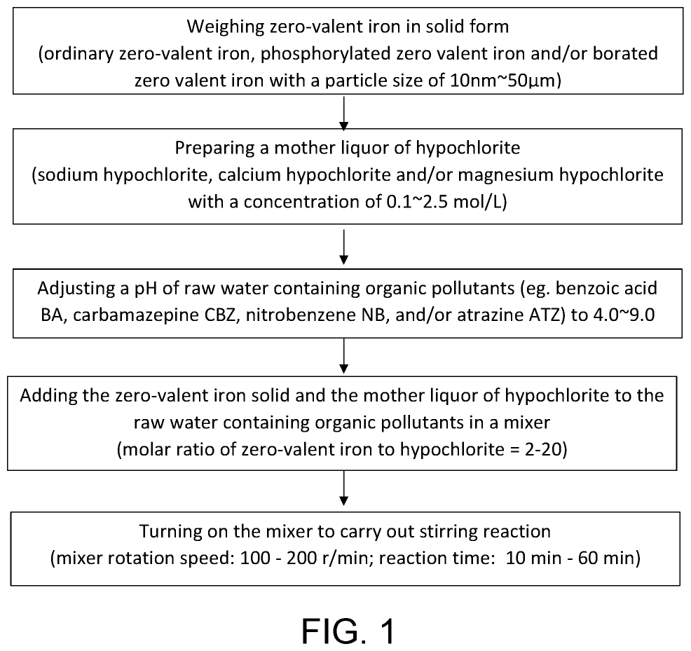

### DETAILED DESCRIPTION OF THE PREFERRED EMBODIMENT

Embodiment 1: The method for zero-valent iron enhanced hypochlorite to remove organic pollutants in water according to this embodiment of the present invention comprises the following steps:

(a) weighing zero-valent iron in solid form;

(b) preparing a mother liquor of hypochlorite;

(c) adjusting a pH of raw water containing organic pollutants to 4.0˜9.0;

(d) adding the zero-valent iron solid and the mother liquor of hypochlorite to the raw water containing organic pollutants in a mixer, where a final concentration of hypochlorite in the mixer is 0.02˜5 mmol/L; and

(e) turning on the mixer to carry out stirring reaction to remove the organic pollutants in the raw water.

Embodiment 2: The difference between this embodiment and the Embodiment 1 is that: the zero-valent iron in step (a) is selected from the group consisting of ordinary zero valent iron, phosphorylated (modified) zero valent iron and borated (modified) zero valent iron.

Embodiment 3: The difference between this embodiment and the Embodiment 1 or the Embodiment 2 is that: a particle size of the zero-valent iron in step (a) is 10 nm˜50 μm.

Embodiment 4: The difference between this embodiment and one of the Embodiments 1-3 is that: a concentration of the mother liquor of hypochlorite in step (b) is 0.1˜2.5 mol/L.

Embodiment 5: The difference between this embodiment and one of the Embodiments 1-4 is that: the hypochlorite in step (b) is selected from one or more of the group consisting of: sodium hypochlorite, calcium hypochlorite and magnesium hypochlorite.

Embodiment 6: The difference between this embodiment and one of the Embodiments 1-5 is that: the organic pollutants in the raw water in step (c) is one or more of benzoic acid (BA), atrazine (ATZ), carbamazepine (CBZ), and nitrobenzene (NB).

Embodiment 7: The difference between this embodiment and one of the Embodiments 1-6 is that: the pH of raw water containing organic pollutants in step (c) is adjusted to 4.0˜7.0.

Embodiment 8: The difference between this embodiment and one of the Embodiments 1-7 is that: a molar ratio of the zero-valent iron solid to the hypochlorite in step (d) is 2-20.

Embodiment 9: The difference between this embodiment and one of the Embodiments 1-8 is that: a rotation speed of the mixer in step (e) is 100˜200 r/min.

Embodiment 10: The difference between this embodiment and one of the Embodiments 1-8 is that: a reaction time of the stirring reaction in step (e) is 10 min˜60 min.

Example 1: According to this example, the method of zero-valent iron enhanced hypochlorite to remove organic pollutants in water comprises the steps of:

(a) weighing 10 mg of zero-valent iron in solid form;

(b) preparing a mother liquor of sodium hypochlorite having a concentration of 100 mmol/L;

(c) adjusting a pH of raw water containing BA to 4.0, where the concentration of BA in the raw water is 10 μmol/L;

(d) adding the 10 mg of zero-valent iron in solid form and the mother liquor of sodium hypochlorite to 1 L of the raw water in a mixer, where a final concentration of sodium hypochlorite in the mixer (the concentration of sodium hypochlorite in the raw water after adding the mother liquor of sodium hypochlorite) is 50˜60 μmol/L; and

(e) turning on the mixer to carry out stirring reaction at a speed of 200 r/min for 15 minutes to remove the organic pollutants in the raw water.

In this example, the comparative examples are adding zero-valent iron alone and sodium hypochlorite alone. The removal rate of BA in this example is 88%, compared to the removal rate of 3% by adding sodium hypochlorite alone and the removal rate of 40% by using zero-valent iron alone. In other words, the removal rate is increased from 3% and 40% to 88%.

Example 2: According to this example, the method of zero-valent iron enhanced hypochlorite to remove organic pollutants in water comprises the steps of:

(a) weighing 20 mg of zero-valent iron in solid form;

(b) preparing a mother liquor of sodium hypochlorite having a concentration of 100 mmol/L;

(c) adjusting a pH of raw water containing ATZ to 4.5, where the concentration of ATZ in the raw water is 3 μmol/L;

(d) adding the weighed 20 mg of zero-valent iron in solid form and the mother liquor of sodium hypochlorite to 1 L of the raw water in a mixer, where a final concentration of sodium hypochlorite in the mixer is 100˜200 μmol/L; and

(e) turning on the mixer to carry out stirring reaction at a speed of 200 r/min for 30 minutes to remove the organic pollutants in the raw water.

In this example, the comparative examples are adding zero-valent iron alone and adding sodium hypochlorite alone. The removal rate of ATZ in this example is 92%, compared to the removal rate of 10% by adding sodium hypochlorite alone and the removal rate of 5% by using zero-valent iron alone. In other words, the removal rate is increased from 10% and 5% to 92%.

Example 3: According to this example, the method of zero-valent iron enhanced hypochlorite to remove organic pollutants in water comprises the steps of:

(a) weighing 50 mg of zero-valent iron in solid form;

(b) preparing a mother liquor of sodium hypochlorite having a concentration of 500 mmol/L;

(c) adjusting a pH of raw water containing NB to 4.0, where the concentration of ATZ in the raw water is 5 μmol/L;

(d) adding the weighed 50 mg of zero-valent iron in solid form and the mother liquor of sodium hypochlorite to 1 L of the raw water in a mixer, where a final concentration of sodium hypochlorite in the mixer is 70˜80 μmol/L; and

(e) turning on the mixer to carry out stirring reaction at a speed of 200 r/min for 60 minutes to remove the organic pollutants in the raw water.

In this example, the comparative examples are adding zero-valent iron alone and adding sodium hypochlorite alone. The removal rate of NB in this example is 89%, compared to the removal rate of 12% by adding sodium hypochlorite alone and the removal rate of 24% by using zero-valent iron alone. In other words, the removal rate is increased from 12% and 24% to 89%.

Example 4: According to this example, the method of zero-valent iron enhanced hypochlorite to remove organic pollutants in water comprises the steps of:

(a) weighing 5 mg of zero-valent iron in solid form;

(b) preparing a mother liquor of calcium hypochlorite having a concentration of 100 mmol/L;

(c) adjusting a pH of raw water containing CBZ to 4.0, where the concentration of CBZ in the raw water is 5 μmol/L;

(d) adding the weighed 5 mg of zero-valent iron in solid form and the mother liquor of calcium hypochlorite to 1 L of the raw water in a mixer, where a final concentration of calcium hypochlorite in the mixer is 20˜30 μmol/L; and

(e) turning on the mixer to carry out stirring reaction at a speed of 200 r/min for 20 minutes to remove the organic pollutants in the raw water.

In this example, the comparative examples are adding zero-valent iron alone and adding calcium hypochlorite alone. The removal rate of CBZ in this example is 93%, compared to the removal rate of 23% by adding calcium hypochlorite alone and the removal rate of 5% by using zero-valent iron alone. In other words, the removal rate is increased from 23% and 5% to 93%.

Example 5: According to this example, the method of zero-valent iron enhanced hypochlorite to remove organic pollutants in water comprises the steps of:

(a) weighing 30 mg of zero-valent iron in solid form;

(b) preparing a mother liquor of sodium hypochlorite having a concentration of 200 mmol/L;

(c) adjusting a pH of raw water containing SMX to 4.5, where the concentration of SMX in the raw water is 5 μmol/L;

(d) adding the weighted 30 mg of zero-valent iron in solid form and the mother liquor of sodium hypochlorite to 1 L of the raw water in a mixer, where a final concentration of sodium hypochlorite in the mixer is 30˜40 μmol/L; and

(e) turning on the mixer to carry out stirring reaction at a speed of 200 r/min for 45 minutes to remove the organic pollutants in the raw water.

In this example, the comparative examples are adding zero-valent iron alone and sodium hypochlorite alone. The removal rate of SMX in this example is 93%, compared to the removal rate of 10% by adding sodium hypochlorite alone and the removal rate of 5% by using zero-valent iron alone. In other words, the removal rate is increased from 10% and 5% to 93%.

Example 6: According to this example, the method of zero-valent iron enhanced hypochlorite to remove organic pollutants in water comprises the steps of:

(a) weighing 80 mg of zero-valent iron in solid form;

(b) preparing a mother liquor of calcium hypochlorite having a concentration of 300 mmol/L;

(c) adjusting a pH of raw water containing phenol to 5.0, where the concentration of phenol in the raw water is 10 μmol/L;

(d) adding the weighed 80 mg of zero-valent iron in solid form and the mother liquor of calcium hypochlorite to 1 L of the raw water in a mixer, where a final concentration of calcium hypochlorite in the mixer is 35˜50 μmol/L; and

(e) turning on the mixer to carry out stirring reaction at a speed of 200 r/min for 20 minutes to remove the organic pollutants in the raw water.

In this example, the comparative examples are adding zero-valent iron alone and adding calcium hypochlorite alone. The removal rate of phenol in this example is 95%, compared to the removal rate of 30% by adding calcium hypochlorite alone and the removal rate of 5% by using zero-valent iron alone. In other words, the removal rate is increased from 30% and 5% to 95%.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A method of removing organic pollutants in water by zero-valent iron enhanced hypochlorite, comprising the steps of:
(a) weighing zero-valent iron in solid form;
(b) preparing a mother liquor of hypochlorite;
(c) adjusting a pH of raw water containing organic pollutants to 4.0˜9.0;
(d) adding the zero-valent iron solid and the mother liquor of hypochlorite to the raw water containing organic pollutants in a mixer, where a final concentration of hypochlorite in the mixer is 0.02˜5 mmol/L; and
(e) turning on the mixer to carry out stirring reaction to remove the organic pollutants in the raw water.

2. The method according to claim 1, characterized in that, the zero-valent iron in step (a) is selected from the group consisting of ordinary zero-valent iron, phosphorylated zero valent iron and borated zero valent iron.

3. The method according to claim 1, wherein a particle size of the zero-valent iron in step (a) is 10 nm˜50 μm.

4. The method according to claim 1, wherein a concentration of the mother liquor of hypochlorite in step (b) is 0.1˜2.5 mol/L.

5. The method according to claim 1, wherein the hypochlorite in step (b) is selected from one or more of the group consisting of: sodium hypochlorite, calcium hypochlorite and magnesium hypochlorite.

6. The method according to claim 1, wherein the organic pollutants in the raw water in step (c) is one or more of benzoic acid, atrazine, carbamazepine and nitrobenzene.

7. The method according to claim 1, wherein the pH of raw water containing organic pollutants in step (c) is adjusted to 4.0-7.0.

8. The method according to claim 1, wherein a molar ratio of the zero-valent iron in solid form to the hypochlorite in step (d) is 2-20.

9. The method according to claim 1, wherein a rotation speed of the mixer in step (e) is 100-200 r/min.

10. The method according to claim 1, wherein a reaction time of the stirring reaction in step (e) is 10 min-60 min.
